(19) United States
(12) Patent Application Publication
(10) Pub. No.: US 2024/0346214 A1
(43) Pub. Date: Oct. 17, 2024

(54) METHOD FOR PREDICTING FLOW AND HEAT TRANSFER PERFORMANCE OF ALL FLOW PATTERNS IN CRUDE OIL HEAT EXCHANGER

(71) Applicant: China University of Petroleum (East China), Qingdao (CN)

(72) Inventors: Xinyue Duan, Qingdao (CN); Manrui Xu, Qingdao (CN); Liang Gong, Qingdao (CN); Chuanyong Zhu, Qingdao (CN); Binghuan Huang, Qingdao (CN); Yuling Lv, Qingdao (CN); Minghai Xu, Qingdao (CN)

(73) Assignee: China University of Petroleum (East China), Qingdao (CN)

(21) Appl. No.: 18/537,396

(22) Filed: Dec. 12, 2023

(30) Foreign Application Priority Data
Apr. 17, 2023 (CN) 202310408100.7

(51) Int. Cl. G06F 30/28

(52) U.S. Cl. CPC G06F 30/28; F28F 2200/00; G06F 2113/08; G06F 2119/08

(57) ABSTRACT

The present disclosure describes a method for predicting flow and heat transfer performance of all flow patterns in a crude oil heat exchanger, including: constructing an all-flow-pattern oil-water two-phase flow prediction model; inputting parameters of a to-be-tested fluid to the all-flow-pattern oil-water two-phase flow prediction model, and determining a dispersed phase of the to-be-tested fluid with an oil-water phase inversion model, according to the dispersed phase of the to-be-tested fluid is a water phase or an oil phase, solving a water drop or an oil drop distribution based fully coupled population balance model (PBM) until convergence to obtain a first result or a second result, determine a flow pattern of the to-be-tested fluid, and flow and heat transfer associated parameters according to the first result or the second result; determining an overall heat transfer coefficient of a heat exchanger.

### CROSS REFERENCE TO RELATED APPLICATION

This patent application claims the benefit and priority of Chinese Patent Application No. 202310408100.7, filed with the China National Intellectual Property Administration on Apr. 17, 2023, the disclosure of which is incorporated by reference herein in its entirety as part of the present application.

### TECHNICAL FIELD

The present disclosure relates to the technical field of an oil-water two-phase flow in petrochemical engineering, and in particular to a method for predicting flow and heat transfer performance of all flow patterns in a crude oil heat exchanger.

### BACKGROUND

In the field of petrochemical engineering, in order to prevent viscosity increment, large transportation resistance and other problems of crude oil produced liquid in long-distance transportation due to heat dissipation of a pipeline, the crude oil produced liquid is subjected to dehydration, pressurization, heating, pour-point reduction and viscosity reduction through a gathering-transportation joint station before transported. In the field of oilfield production, the gathering-transportation joint station is a sector with high energy consumption. A heat exchanger is considered as an important device for heating the crude oil in dehydration and transportation, and its heat transfer efficiency is of importance to energy conservation and consumption reduction. At present, a fluid-solid coupled heat transfer process between the crude oil produced liquid and hot water in the heat exchanger involves a series of complicated evolution mechanisms of an oil-water two-phase flow, and the heat transfer efficiency of the heat exchanger is far lower than its designed condition. Evidence shows that the flow and heat transfer performance of the oil-water two-phase flow heat exchanger is closely associated with an oil-water two-phase flow pattern. When extracted, the crude oil produced liquid has different water contents in different stages to cause a varied flow pattern in the heat exchanger. There is a water-in-oil dispersed flow, a stratified flow, an oil-in-water dispersed flow, a hybrid dispersed flow, a hybrid stratified flow, etc. The flow and heat transfer performance of the heat exchanger is unpredictable.

Concerning typical numerical methods for the oil-water two-phase flow, a volume of fluid (VOF) model, a mixture model and a two-fluid model (TFM) are provided. A TFM and population balance model (PBM) coupled model has been researched with preliminary advances in the field. However, most of the above numerical methods are applicable to predict the flow and heat transfer characteristics of single flow patterns in the oil-water two-phase flow. No numerical investigation is conducted on various flow patterns in the water-in-oil dispersed flow, the stratified flow, the oil-in-water dispersed flow, the hybrid dispersed flow, the hybrid stratified flow, as well as on the oil-water two-phase fluid-solid coupled heat transfer in the crude oil heat exchanger. Therefore, the flow and heat transfer characteristics for various flow patterns cannot be predicted in the prior art.

### SUMMARY

In view of shortages of the prior art, an objective of the present disclosure is to provide a method for predicting flow and heat transfer performance of all flow patterns in a crude oil heat exchanger, to solve the problem that flow and heat transfer characteristics for various flow patterns cannot be predicted in the prior art.

To achieve the above objective, the present disclosure provides the following technical solutions.

A method for predicting flow and heat transfer performance of all flow patterns in a crude oil heat exchanger includes:

constructing an all-flow-pattern oil-water two-phase flow prediction model, the all-flow-pattern oil-water two-phase flow prediction model including an oil-water phase inversion model, an oil drop distribution based fully coupled PBM, and a water drop distribution based fully coupled PBM;

inputting parameters of a to-be-tested fluid to the all-flow-pattern oil-water two-phase flow prediction model, and determining a dispersed phase of the to-be-tested fluid with the oil-water phase inversion model, specifically, if the dispersed phase of the to-be-tested fluid is a water phase, solving the water drop distribution based fully coupled PBM until convergence to obtain a first result, and determining a flow pattern of the to-be-tested fluid, and flow and heat transfer associated parameters according to the first result; and if the dispersed phase of the to-be-tested fluid is an oil phase, solving the oil drop distribution based fully coupled PBM until convergence to obtain a second result, and determining a flow pattern of the to-be-tested fluid, and flow heat transfer associated parameters according to the second result; and

determining an overall heat transfer coefficient of a heat exchanger according to the flow pattern of the to-be-tested fluid and the flow and heat transfer associated parameters.

Preferably, the constructing an all-flow-pattern oil-water two-phase flow prediction model includes:

obtaining a fluid-solid coupled flow and heat transfer unit in the heat exchanger;

acquiring structural parameters of the heat exchanger according to the flow and heat transfer unit;

constructing a physical model according to the structural parameters of the heat exchanger and performing mesh generation; and

constructing the all-flow-pattern oil-water two-phase flow prediction model according to the oil-water phase inversion model, the oil drop distribution based fully coupled PBM, and the water drop distribution based fully coupled PBM.

Preferably, the parameters of a to-be-tested fluid include:

an oil-water two-phase flow velocity, an oil-water two-phase phase holdup, an oil-water two-phase viscosity, and an oil-water two-phase density.

Preferably, the determining a dispersed phase of the to-be-tested fluid with the oil-water phase inversion model includes:

calculating an input oil-water two-phase phase holdup of the to-be-tested fluid with a phase inversion point (PIP) empirical correlation of the phase inversion model to obtain an oil-water two-phase phase holdup in phase inversion; and

comparing the oil-water two-phase phase holdup in the phase inversion with the input oil-water two-phase phase holdup of the to-be-tested fluid to determine the dispersed phase of the to-be-tested fluid.

Preferably, the phase inversion model includes:

a low-viscosity oil phase inversion model, an intermediate-viscosity oil phase inversion model, and a high-viscosity oil phase inversion model.

Preferably, the flow pattern of the to-be-tested fluid includes:

a water-in-oil dispersed flow, a stratified flow, an oil-in-water dispersed flow, a hybrid dispersed flow, a hybrid stratified flow, an intermittent flow, and an annular flow.

Preferably, the flow and heat transfer associated parameters include:

an oil-water two-phase phase holdup distribution field, a size distribution, a pressure field, a pressure drop field, and a temperature field.

Preferably, the determining an overall heat transfer coefficient of a heat exchanger according to the flow pattern of the to-be-tested fluid, and the flow and heat transfer associated parameters includes:

determining the flow pattern of the to-be-tested fluid according to the two-phase phase holdup distribution field and the size distribution;

calculating a local Nusselt number of the heat exchanger with the pressure field and the temperature field based on the flow pattern of the to-be-tested fluid to obtain a local deteriorated region of the heat exchanger;

calculating a Nusselt number and a Fanning friction factor of the heat exchanger according to the local deteriorated region of the heat exchanger; and

calculating the overall heat transfer coefficient of the heat exchanger according to the Nusselt number and the Fanning friction factor of the heat exchanger.

According to specific embodiments provided in the present disclosure, the present disclosure has the following technical effects:

According to the method for predicting flow and heat transfer performance of all flow patterns in a crude oil heat exchanger provided by the present disclosure, the present disclosure measures influences of various flow patterns on the heat exchanger in combination with an oil-water phase inversion model and two liquid-liquid PBMs. The present disclosure expands an application range of performance prediction of the heat exchanger on the flow pattern, and improves a prediction accuracy.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a first flow chart of a method for predicting flow and heat transfer performance of all flow patterns in a crude oil heat exchanger according to an embodiment of the present disclosure;

FIG. 2 is a schematic view of an all-flow-pattern oil-water two-phase flow prediction model according to an embodiment of the present disclosure;

FIG. 3 is a second flow chart of a method for predicting flow and heat transfer performance of all flow patterns in a crude oil heat exchanger according to an embodiment of the present disclosure;

FIG. 4 illustrates contour lines of phase distribution obtained by solving a fully coupled PBM according to an embodiment of the present disclosure;

FIG. 5 is a variation chart of a local Nusselt number with a local oil content according to an embodiment of the present disclosure; and

FIG. 6 is a variation chart of an overall heat transfer coefficient with an inlet Reynolds number according to an embodiment of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a method for predicting flow and heat transfer performance of all flow patterns in a crude oil heat exchanger, to solve the problem that flow and heat transfer characteristics for various flow patterns cannot be predicted in the prior art.

In order to make the above objective, features and advantages of the present disclosure clearer and more comprehensible, the present disclosure will be further described in detail below in combination with accompanying drawings and particular implementation modes.

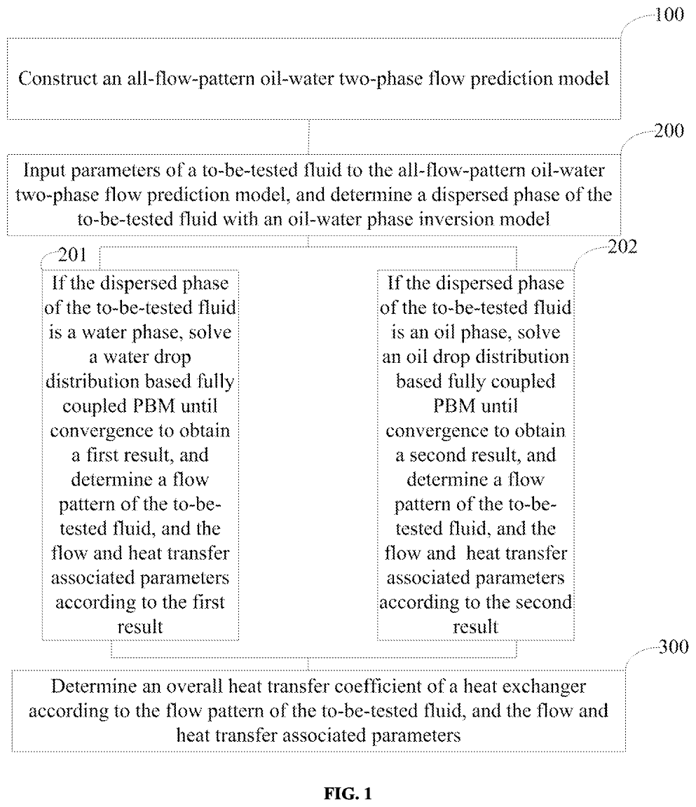

As shown in FIG. 1, the present disclosure provides a method for predicting flow and heat transfer performance of all flow patterns in a crude oil heat exchanger, including the following steps:

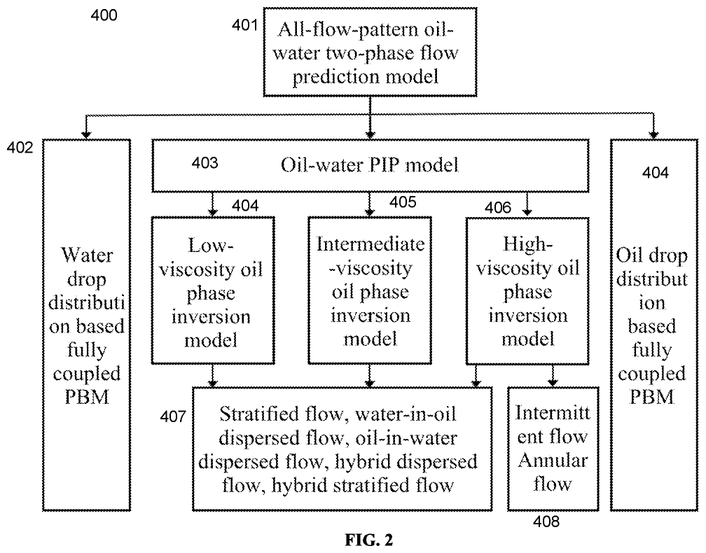

Step 100: An all-flow-pattern oil-water two-phase flow prediction model (401) is constructed, the all-flow-pattern oil-water two-phase flow prediction model including an oil-water phase inversion model (403), an oil drop distribution based fully coupled PBM (404), and a water drop distribution based fully coupled PBM (402), as shown in FIG. 2. The oil-water phase inversion model 403 can include a low-viscosity oil phase inversion model 404, an intermediate-viscosity oil phase inversion model 405, and a high-viscosity oil phase inversion model 406 that can be used to calculate stratified flow, water-in-oil dispersed flow, oil-in-water dispersed flow, hybrid dispersed flow, and hybrid stratified flow (407) and an intermittent annular flow (408).

Step 200: Parameters of a to-be-tested fluid is input to the all-flow-pattern oil-water two-phase flow prediction model, and a dispersed phase of the to-be-tested fluid is determined with the oil-water phase inversion model.

Step 201: If the dispersed phase of the to-be-tested fluid is a water phase, the water drop distribution based fully coupled PBM is solved until convergence to obtain a first result, and a flow pattern of the to-be-tested fluid, and the flow and heat transfer associated parameters are determined according to the first result.

Step 202: If the dispersed phase of the to-be-tested fluid is an oil phase, the oil drop distribution based fully coupled PBM is solved until convergence to obtain a second result, and a flow pattern of the to-be-tested fluid, and flow and heat transfer associated parameters are determined according to the second result.

Step 300: An overall heat transfer coefficient of a heat exchanger is determined according to the flow pattern of the to-be-tested fluid, and the flow and heat transfer associated parameters.

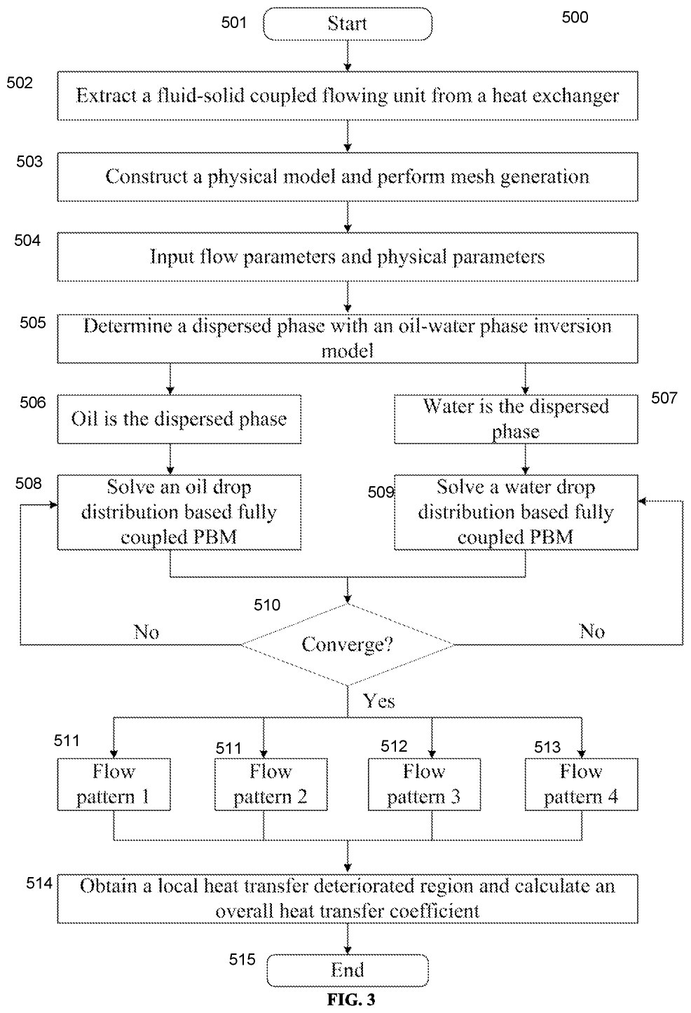

As shown in FIG. 3, the all-flow-pattern prediction method 500 starting at 501 for flow and heat transfer performance of a crude oil heat exchanger in the embodiment specifically includes the following steps:

Step 502: A fluid-solid coupled flow and heat transfer unit is obtained from a crude oil heat exchanger.

Step 503: Structural parameters of the heat exchanger are extracted, a physical model is constructed and mesh generation is performed.

Step 504: Flow parameters and physical parameters are inputted.

Step 505: A dispersed phase is determined with an oil-water PIP model.

Step 507: When it is determined that water is the dispersed phase in Step 505, a water drop distribution based fully coupled PBM is solved, or otherwise at step 506, an oil drop distribution based fully coupled PBM is solved.

Steps 510-513: A flow pattern of an oil-water two-phase flow, and flow and heat transfer characteristics in the heat exchanger are obtained, a local Nusselt number and an overall Nusselt number of the heat exchanger are calculated, a local heat transfer deteriorated region is analyzed, and an overall heat transfer coefficient is calculated at step 514.

Specifically, the step that an all-flow-pattern oil-water two-phase flow prediction model is constructed includes:

A fluid-solid coupled flow and heat transfer unit in the heat exchanger is obtained.

Structural parameters of the heat exchanger are acquired according to the flow and heat transfer unit.

A physical model is constructed according to the structural parameters of the heat exchanger and mesh generation is performed.

The all-flow-pattern oil-water two-phase flow prediction model is constructed according to the oil-water phase inversion model, the oil drop distribution based fully coupled PBM, and the water drop distribution based fully coupled PBM.

Further, the parameters of a to-be-tested fluid include:

an oil-water two-phase flow velocity, an oil-water two-phase phase holdup, an oil-water two-phase viscosity, and an oil-water two-phase density.

Further, the step that a dispersed phase of the to-be-tested fluid is determined with the oil-water phase inversion model includes:

An input oil-water two-phase phase holdup of the to-be-tested fluid is calculated with a PIP empirical correlation of the phase inversion model to obtain an oil-water two-phase phase holdup in phase inversion.

The oil-water two-phase phase holdup in the phase inversion is compared with the input oil-water two-phase phase holdup of the to-be-tested fluid to determine the dispersed phase of the to-be-tested fluid.

Specifically, the phase inversion model includes:

A low-viscosity oil phase inversion model, an intermediate-viscosity oil phase inversion model, and a high-viscosity oil phase inversion model.
(a) The low-viscosity oil phase inversion model (μₒ<50 mPa·s) is given by:

$$\frac{{ρ}_{o}}{{ρ}_{w}} \frac{{μ}_{o}}{{μ}_{w}} \frac{( 1.5 - 0.5 {ε}_{w} ) {( 1 - {ε}_{w} )}^{2}}{{ε}_{w}^{2} ( 1 + 0.5 {ε}_{w} )} = 1 \qquad ( 1 )$$

(b) The intermediate-viscosity oil phase inversion model (50 m Pa·s<μₒ<100 mPa·s) is given by:

$$\frac{{ε}_{o}}{1 - {ε}_{o}} = {( \frac{{ρ}_{o}}{{ρ}_{w}} )}^{0.6} {( \frac{{μ}_{o}}{{μ}_{w}} )}^{0.4} \qquad ( 2 )$$

(c) The high-viscosity oil phase inversion model (100 mPa·s<μₒ<300 mPa·s) is given by:

$${ε}_{1} = \frac{1}{1 + {( \frac{{ρ}_{o}}{{ρ}_{w}} \cdot \frac{{μ}_{o}}{{μ}_{w}} )}^{0.4}} \qquad ( 3 )$$

$$\frac{{ε}_{1}}{1 - {ε}_{2}} = \frac{{C ( {d}_{32} )}_{w / o ( 1 )}}{{( {d}_{32} )}_{o , w ( 2 )}} \qquad ( 4 )$$

$${( {d}_{32} )}_{w / o ( 1 )} = \frac{7.61 {C}_{H} D}{{k}_{d}} {( \frac{{σ}_{o w}}{{ρ}_{o} {DU}_{m}^{2}} )}^{0.6} {( \frac{{ρ}_{o} {U}_{m} D}{{μ}_{o}} )}^{0.08} {( \frac{{ρ}_{o}}{{ρ}_{m}} )}^{0.4} \frac{{ε}_{1}^{0.6}}{{( 1 - {ε}_{1} )}^{0.2}} \qquad ( 5 )$$

$${( {d}_{32} )}_{o / w ( 2 )} = \frac{7.61 {C}_{H} D}{{k}_{d}} {( \frac{{σ}_{o w}}{{ρ}_{w} D {U}_{m}^{2}} )}^{0.6} {( \frac{{ρ}_{w} {U}_{m} D}{{μ}_{w}} )}^{0.08} {( \frac{{ρ}_{w}}{{ρ}_{m}} )}^{0.4} \frac{{( 1 - {ε}_{2} )}^{0.6}}{{ε}_{2}^{0.2}} \qquad ( 6 )$$

$${( \frac{{ε}_{1}}{1 - {ε}_{2}} )}^{0.4} {( \frac{1 - {ε}_{1}}{{ε}_{2}} )}^{0.2} = {C ( \frac{{ρ}_{w}}{{ρ}_{o}} )}^{0.12} {( \frac{{μ}_{w}}{{μ}_{o}} )}^{0.08} \qquad ( 7 )$$

$${ε}_{w} = {ε}_{1} + K ( {ε}_{2} - {ε}_{1} ) \qquad ( 8 )$$

$$300 mPa \cdot s < {μ}_{o} < 5000 mPa \cdot s$$

$${ε}_{w} = \frac{{ρ}_{w} / ( {ρ}_{w} - {ρ}_{o} )}{\frac{{ρ}_{w}}{{ρ}_{o}} + {( \frac{{μ}_{0}}{{μ}_{w}} )}^{0.51}} ( {ρ}_{o} < 972 kg / {m}^{3} ) \qquad ( 9 )$$

$${ε}_{w} = 0.5 - 0.110811 g {μ}_{o} ( {ρ}_{o} > 972 kg / {m}^{3} ) \qquad ( 10 )$$

In Equation 1 to Equation 10, ρₒ and ρ_{w} are respectively a density of an oil phase and a density of a water phase, μₒ and μ_{w} are respectively a viscosity of the oil phase and a viscosity of the water phase, ε_{w} is a critical water content in the phase inversion, εₒ is a critical oil content in the phase inversion, C and K are constants and are 1.05 and 0.3 respectively, ε₁ is a critical water content of a water-in-oil flow pattern, ε₂ is a critical water content of an oil-in-water flow pattern, (d₃₂)_{w/o(1)} is a Sauter mean diameter of a liquid drop in a water-in-oil critical state, (d₃₂)_{o/w(2)} is a Sauter mean diameter of a liquid drop in an oil-in-water critical state, k_{d} is a constant depending on a fluid system, C_{H} is an adjustable constant, D is a pipe diameter, and Uₘ is a mixing velocity.

Specifically, the flow pattern of the to-be-tested fluid includes:

a water-in-oil dispersed flow, a stratified flow (407), an oil-in-water dispersed flow (407), a hybrid dispersed flow (407), a hybrid stratified flow (407), an intermittent flow (408), and an annular flow. The flow pattern is complicated under the influence of various factors such as a flow velocity, a water content, a physical property and a temperature.

Specifically, the following equations are used to solve the oil drop distribution based fully coupled PBM or the water drop distribution based fully coupled PBM:

Concerning the water drop distribution based fully coupled PBM (oil is a continuous phase):

### (a) TFM

A continuity equation of the oil phase is given by:

$$∇ \cdot ( {α}_{o} {ρ}_{o} {u}_{o} ) = 0 \qquad ( 11 )$$

A momentum equation of the oil phase is given by:

$$∇ \cdot ( {α}_{o} {ρ}_{o} {u}_{o} {u}_{o} ) = - {α}_{o} ∇ P + {α}_{o} {ρ}_{o} g + ∇ \cdot [ {α}_{o} {μ}_{e , o} ( ∇ {u}_{o} + {( ∇ {u}_{o} )}^{T} ) ] + {F}_{o} \qquad ( 12 )$$

An energy equation of the oil phase is given by:

$$∇ \cdot ( {α}_{o} {ρ}_{o} {u}_{o} {c}_{p , o} {T}_{o} ) = ∇ \cdot ( {α}_{o} {λ}_{o} ∇ {T}_{o} ) - {\dot{Q}}_{w , o} \qquad ( 13 )$$

A continuity equation of the water phase is given by:

$$∇ \cdot ( {α}_{w} {ρ}_{w} {u}_{w} {f}_{i} ) = {s}_{di}^{w} \qquad ( 14 )$$

$$∇ \cdot ( {α}_{w} {ρ}_{w} {u}_{w} ) = 0 \qquad ( 15 )$$

A momentum equation of the water phase is given by:

$$∇ \cdot ( {α}_{w} {ρ}_{w} {u}_{w} {u}_{w} ) = - {α}_{w} ∇ P + {α}_{w} {ρ}_{w} g + ∇ \cdot [ {α}_{w} {μ}_{e , w} ( ∇ {u}_{w} + {( ∇ {u}_{w} )}^{T} ) ] + {F}_{w o} \qquad ( 16 )$$

An energy equation of the water phase is given by:

$$∇ \cdot ( {α}_{w} {ρ}_{w} {u}_{w} {c}_{p , w} {T}_{w} ) = ∇ \cdot ( {α}_{w} {λ}_{w} ∇ {T}_{w} ) + {\dot{Q}}_{w , o} \qquad ( 17 )$$

In Equation 11 to Equation 17:

αₒ is a volume fraction of the oil phase, α_{w} is a volume fraction of the water phase, ρₒ is a density of the oil phase, ρ_{w} is a density of the water phase, uₒ is a velocity vector of the oil phase, u_{w} is a velocity vector of the water phase, μ_{e,o} is an effective viscosity of the oil phase, μ_{e,w} is an effective viscosity of the water phase, Fₒ and F_{wo} respectively represent an inter-phase force of the oil phase and an inter-phase of the water phase, Tₒ is a temperature of the oil phase, T_{w} is a temperature of the water phase, c_{p,o} is constant-pressure specific heat of the oil phase, c_{p,w} is constant-pressure specific heat of the water phase, λₒ is a heat conductivity coefficient of the oil phase, λ_{w} is a heat conductivity coefficient of the water phase, \dot{Q}_{w,o} is an interfacial transfer energy from the oil phase to the water phase, g is a gravity acceleration, fᵢ represents a percent for an ith group of liquid drops, ∇P represents a pressure, and S_{di}^{w} represents an added mass source item of the water phase caused by water drop accumulation and rupture, and g is a gravity acceleration.

The effective viscosity μ_{e,o} in the equation of the continuous phase (oil phase) includes a turbulent viscosity μ_{T,o} of the oil phase and an induced viscosity μ_{BI,w} of the water phase:

$${μ}_{e , o} = {μ}_{T , o} + {μ}_{BI , w} \qquad ( 18 )$$

(b) Homogeneous Phase k-ε Turbulent Model:

A shear-induced turbulent viscosity coefficient in the k-ε model is represented by a turbulent kinetic energy and a turbulent dissipation rate:

$${μ}_{o}^{t} = {ρ}_{o} {C}_{μ} {k}_{o}^{2} / {ε}_{o} \qquad ( 19 )$$

In Equation 19:

μₒ^{t} is the shear-induced turbulent viscosity coefficient, ρₒ is the density of the oil phase, kₒ is a turbulent kinetic energy of the oil phase, εₒ is a turbulent dissipation rate of the oil phase, and C_{μ} is a constant of the turbulent model.

The turbulent kinetic energy k and the turbulent dissipation rate ε satisfy:

$$\frac{\partial {ρ}_{o} {α}_{o} {k}_{o}}{\partial t} + ∇ \cdot ( {ρ}_{o} {α}_{o} {u}_{o} {k}_{o} ) = - ∇ \cdot ( {α}_{o} - \frac{{μ}_{o}^{t}}{{σ}_{k}} ∇ \cdot {k}_{o} ) + {α}_{o} ( {G}_{k} - {ρε}_{o} ) - {Y}_{M} + {G}_{w} \qquad ( 20 )$$

$$\frac{\partial {ρ}_{o} {α}_{o} {ε}_{o}}{\partial t} + ∇ \cdot ( {ρ}_{o} {α}_{o} {u}_{o} {ε}_{o} ) = - ∇ \cdot ( {α}_{o} \frac{{μ}_{o}^{t}}{{σ}_{ε}} ∇ \cdot {ε}_{o} ) + {c}_{ε1} \frac{{ε}_{o}}{{k}_{o}} ( {G}_{k} - {C}_{ε2} {ρ}_{o} {ε}_{o} ) + {C}_{ε3} \frac{{G}_{w}}{{τ}_{bit}} \qquad ( 21 )$$

Gₖ is a turbulent kinetic energy caused by an average velocity gradient, Y_{M} is a contribution of a fluctuated volume expansivity in a compressible turbulent flow to an overall dissipation rate, G_{w} is a water drop induced turbulent kinetic energy, τ_{bit} represents a turbulent eddy-dissipation characteristic time, C_{ε1}, C_{ε2}, and C_{ε3} represent a constant of the k-ε turbulent model, σₖ and σ_{ε} respectively represent a turbulent Prandtl number of k and a turbulent Prandtl number of ε.

Concerning the oil drop distribution based fully coupled PBM (water is a continuous phase):

### (a) TFM

A continuity equation of the water phase is given by:

$$∇ \cdot ( {α}_{w} {ρ}_{w} {u}_{w} ) = 0 \qquad ( 22 )$$

A momentum equation of the water phase is given by:

$$∇ \cdot ( {α}_{w} {ρ}_{w} {u}_{w} {u}_{D} ) = - {α}_{w} ∇ P + {α}_{w} {ρ}_{w} g + ∇ \cdot [ {α}_{w} {μ}_{e , w} ( ∇ {u}_{w} + {( ∇ {u}_{w} )}^{T} ) ] + {F}_{w} \qquad ( 23 )$$

An energy equation of the water phase is given by:

$$∇ \cdot ( {α}_{w} {ρ}_{w} {u}_{w} {c}_{p , w} {T}_{w} ) = ∇ \cdot ( {α}_{w} {λ}_{w} ∇ {T}_{w} ) - {\dot{Q}}_{o , w} \qquad ( 24 )$$

A continuity equation of the oil phase is given by:

$$∇ \cdot ( {α}_{o} {ρ}_{o} {u}_{o} {f}_{i} ) = {s}_{d i}^{o} \qquad ( 25 )$$

$$∇ \cdot ( {α}_{o} {ρ}_{o} {u}_{o} ) = 0 \qquad ( 26 )$$

A momentum equation of the oil phase is given by:

$$∇ \cdot ( {α}_{o} {ρ}_{o} {u}_{o} {u}_{o} ) = - {α}_{o} ∇ P + {α}_{o} {ρ}_{o} g + ∇ \cdot [ {α}_{o} {μ}_{e , o} ( ∇ {u}_{o} + {( ∇ {u}_{o} )}^{T} ) ] + {F}_{o w} \qquad ( 27 )$$

An energy equation of the oil phase is given by:

$$∇ \cdot ( {α}_{o} {ρ}_{o} {u}_{o} {c}_{p , o} {T}_{o} ) = ∇ \cdot ( {α}_{o} {λ}_{o} ∇ {T}_{o} ) + {\dot{Q}}_{o , w} \qquad ( 28 )$$

αₒ is a volume fraction of the oil phase, α_{w} is a volume fraction of the water phase, ρₒ is a density of the oil phase, ρ_{w} is a density of the water phase, uₒ is a velocity vector of the oil phase, u_{w} is a velocity vector of the water phase, μ_{e,o} is an effective viscosity of the oil phase, μ_{e,w} is an effective viscosity of the water phase, F_{w} and F_{ow} respectively represent an inter-phase force of the oil phase and an inter-phase of the water phase, Tₒ is a temperature of the oil phase, T_{w} is a temperature of the water phase, c_{p,o} is constant-pressure specific heat of the oil phase, c_{p,w} is constant-pressure specific heat of the water phase, λₒ is a heat conductivity coefficient of the oil phase, λ_{w} is a heat conductivity coefficient of the water phase, \dot{Q}_{o,w} is an interfacial transfer energy from the oil phase to the water phase, g is a gravity acceleration, fᵢ represents a percent for an ith group of liquid drops, ∇P represents a pressure, and S_{di}^{o} represents an added mass source item of the water phase caused by water drop accumulation and rupture.

The effective viscosity μ_{e,w} in the equation of the continuous phase (water phase) includes a turbulent viscosity μ_{T,w} of the water phase and an induced viscosity μ_{BI,o} of the oil phase:

$${μ}_{e , w} = {μ}_{T , w} + {μ}_{BI , o} \qquad ( 29 )$$

(b) homogeneous phase k-ε turbulence model:

A shear-induced turbulent viscosity coefficient in the k-ε model is represented by a turbulent kinetic energy and a turbulent dissipation rate:

$${μ}_{w}^{t} = {ρ}_{w} {C}_{μ} {k}_{w}^{2} / {ε}_{w} \qquad ( 30 )$$

μ_{w}^{t} is the shear-induced turbulent viscosity coefficient, ρ_{w} is the density of the water phase, k_{w} is a turbulent kinetic energy of the water phase, ε_{w} is a turbulent dissipation rate of the water phase, and C_{μ} is a constant of the turbulent model.

The turbulent kinetic energy k and the turbulent dissipation rate ε satisfy:

$$\frac{\partial {ρ}_{w} {α}_{w} {k}_{w}}{\partial t} + ∇ \cdot ( {ρ}_{w} {α}_{w} {u}_{w} {k}_{w} ) = - ∇ \cdot ( {α}_{w} \frac{{μ}_{w}^{t}}{{σ}_{k}} ∇ \cdot {k}_{w} ) + {α}_{w} ( {G}_{k} - ρ {ε}_{w} ) - {Y}_{M} + {G}_{o} \qquad ( 31 )$$

$$\frac{\partial {p}_{w} {α}_{w} {ε}_{w}}{\partial t} + ∇ \cdot ( {p}_{w} {α}_{w} {u}_{w} {ε}_{w} ) = - ∇ \cdot ( {α}_{w} \frac{{μ}_{w}^{t}}{{σ}_{ε}} ∇ \cdot {ε}_{w} ) + {C}_{ε 1}^{w} \frac{{ε}_{w}}{{k}_{w}} ( {G}_{k} - {C}_{ε 2}^{w} {ρ}_{w} {ε}_{w} ) + {C}_{ε 3}^{w} \frac{{G}_{o}}{{τ}_{b i t}} \qquad ( 32 )$$

ρ_{w} is a density of the water phase, α_{w} is a volume fraction of the water phase, u_{w} is a velocity vector of the water phase, Gₖ is a turbulent kinetic energy caused by an average velocity gradient, Y_{M} is a contribution of a fluctuated volume expansivity in a compressible turbulent flow to an overall dissipation rate, Gₒ is an oil drop induced turbulent kinetic energy, τ_{bit} represents a turbulent eddy-dissipation characteristic time, C_{ε1}, C_{ε2} and C_{ε3} represent a constant of the k-ε turbulent model, and σₖ and σ_{ε}, respectively, represent a turbulent Prandtl number of k and a turbulent Prandtl number of ε.

Specifically, the flow and heat transfer associated parameters include:

an oil-water two-phase phase holdup distribution field, a size distribution, a pressure field, a pressure drop field, and a temperature field.

Specifically, the step that an overall heat transfer coefficient of a heat exchanger is determined according to the flow pattern of the to-be-tested fluid, and the flow and heat transfer associated parameters include:

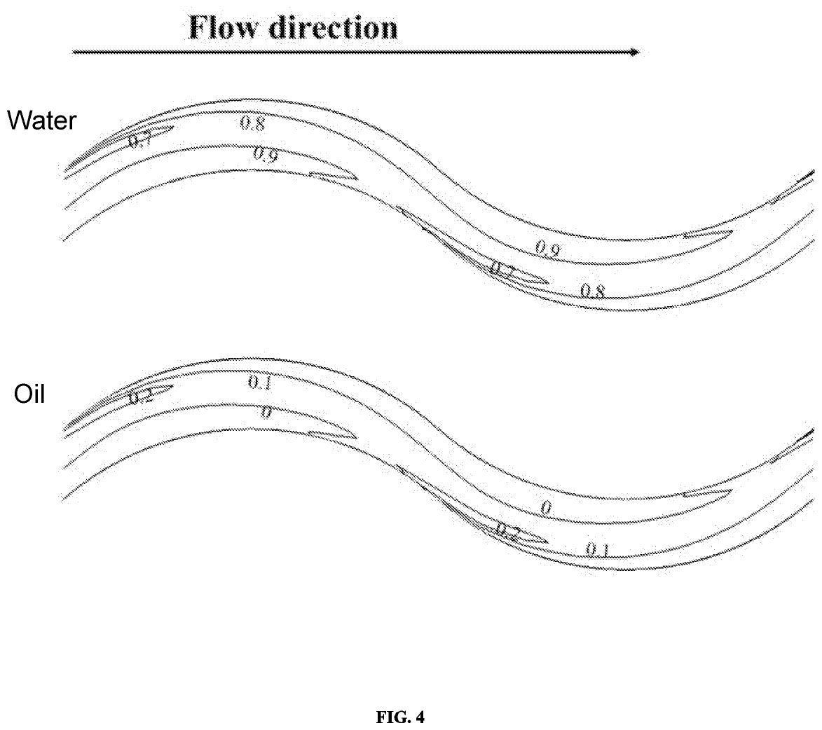

The flow pattern of the to-be-tested fluid is determined according to the oil-water two-phase phase holdup distribution field and the size distribution. FIG. 4 illustrates the contour lines of phase distribution of water and oil.

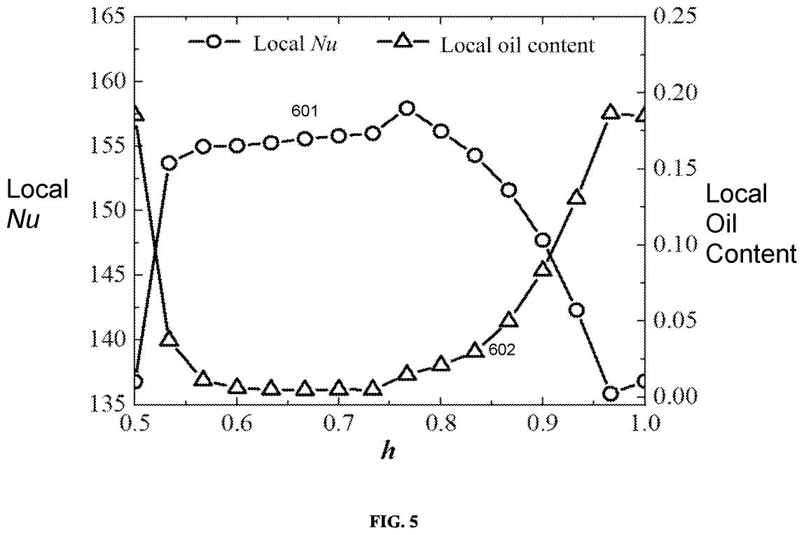

A local Nusselt number of the heat exchanger is calculated with the pressure field and the temperature field based on the flow pattern of the to-be-tested fluid to obtain a local deteriorated region (as shown in FIG. 5, which plots the local Nu 601 and the local oil content 602) of the heat exchanger. Specifically, there are the following equations:

$$N {u}_{x} = \frac{2 {λ}_{p} {D}_{h}}{δ {λ}_{x m}} \frac{( {T}_{P} - {T}_{n} )}{( {T}_{f} - {T}_{n} )} \qquad ( 33 )$$

Dₕ is a hydraulic diameter of the flowing unit, λₓₘ is a cross-sectional average heat conductivity coefficient of the oil-water two-phase flow, δ is a half of a height of a first grid layer on a near wall of a fluid domain, λₚ is a two-phase heat conductivity coefficient in the first grid layer on the near wall of the fluid domain, Tₚ is a temperature of a fluid in the first grid layer on the near wall, Tₙ is a temperature of a local wall, and T_{f} is a temperature of a central fluid.

A Nusselt number and a Fanning friction factor of the heat exchanger are calculated according to the local deteriorated region of the heat exchanger. Specifically, there are the following equations:

### (a) Nusselt Number Nu

$$N u = \frac{\dot{m} {C}_{p} {D}_{h} ( {T}_{i n} - {T}_{o u t} )}{\overline{{λ}_{v m}} {A}_{w} ( \overline{{T}_{w}} - \overline{{T}_{b}} )} \qquad ( 34 )$$

$$\overline{{T}_{b}} = {β}_{o} {T}_{o} + {β}_{w} {T}_{w} \qquad ( 35 )$$

$$\overline{{A}_{vm}} = {α}_{o} {λ}_{o} + {α}_{w} {λ}_{w} \qquad ( 36 )$$

\dot{m} is a mass flow of a hot runner, Cₚ is a specific heat capacity of a heating working medium, Tᵢₙ and Tₒᵤₜ are respectively an inlet temperature and an outlet temperature of the hot runner, λ̅ᵥ̅ₘ̅ is a volumetric average heat conductivity coefficient of the oil-water two-phase flow, A_{w} is an area of a heat transfer surface, T̅_̅{̅b̅}̅ is an average temperature of the oil-water two-phase flow, and T̅_̅{̅w̅}̅ is an average temperature of a heat transfer wall, βₒ is a mass fraction of the oil phase, and β_{w} is a mass fraction of the water phase.

### (b) Fanning Friction Factor f

$$f = \frac{Δ p \times {D}_{h}}{2 \times L \times \overline{{ρ}_{x𝔪}} \times {u}_{m}^{2}} \qquad ( 37 )$$

$$\overline{{ρ}_{x𝔪}} = {α}_{o} {ρ}_{o} + {α}_{w} {ρ}_{w} \qquad ( 38 )$$

Δp is a pressure drop of the flowing unit, L is a length of the flowing unit, ρ̅ₓ̅ₘ̅ is an oil-water two-phase average density, and uₘ is an oil-water two-phase mixing velocity.

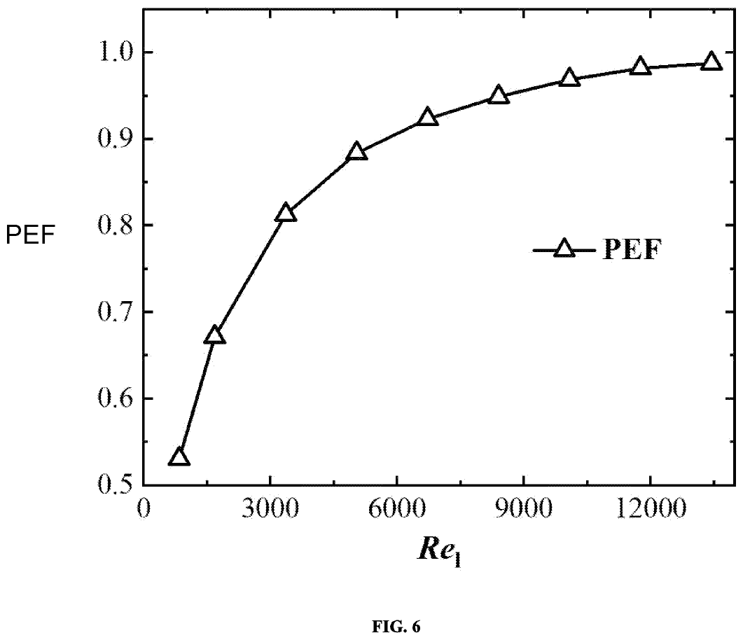

The overall heat transfer coefficient PEF of the heat exchanger is calculated according to the Nusselt number and the Fanning friction factor of the heat exchanger (as shown in FIG. 6).

$$P E F = ( Nu / {Nu}_{0} ) / {( f / {f}_{0} )}^{1 / 3} \qquad ( 39 )$$

Nu₀ and f₀ are respectively a Nusselt number and a Fanning friction factor in a standard working condition. The standard working condition in the present disclosure is a pure-water single-phase flow in a researched working condition.

The present disclosure has the following beneficial effects:

Compared with an existing numerical technology of the oil-water two-phase flow heat exchanger, the present disclosure selects the oil-water PIP empirical correlation based on a viscosity type to determine the dispersed phase. In combination with the water drop distribution based fully coupled PBM and the oil drop distribution based fully coupled PBM, the present disclosure constructs the method for predicting flow and heat transfer performance of all flow patterns in a crude oil heat exchanger and has a wider application range for the flow pattern.

The method for predicting flow and heat transfer performance of all flow patterns in a crude oil heat exchanger provided by the present disclosure can predict local and overall heat transfer performance of each flow pattern in the crude oil heat exchanger under different temperature, pressures, flow velocities, water contents and crude oil viscosities, with a prediction accuracy better than that of a conventional TFM.

Each embodiment in the description is described in a progressive mode, each embodiment focuses on differences from other embodiments, and references can be made to each other for the same and similar parts between embodiments.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A method for predicting flow and heat transfer performance of all flow patterns in a crude oil heat exchanger, comprising:
constructing an all-flow-pattern oil-water two-phase flow prediction model, the all-flow-pattern oil-water two-phase flow prediction model comprising an oil-water phase inversion model, an oil drop distribution based fully coupled population balance model (PBM), and a water drop distribution based fully coupled PBM;
inputting parameters of a to-be-tested fluid to the all-flow-pattern oil-water two-phase flow prediction model,
determining a dispersed phase of the to-be-tested fluid with the oil-water phase inversion model,
if the dispersed phase of the to-be-tested fluid is a water phase, solving the water drop distribution based fully coupled PBM until convergence to obtain a first result, and determining a flow pattern of the to-be-tested fluid and flow and heat transfer associated parameters according to the first result; and
if the dispersed phase of the to-be-tested fluid is an oil phase, solving the oil drop distribution based fully coupled PBM until convergence to obtain a second result, and determining a flow pattern of the to-be-tested fluid and flow heat transfer associated parameters according to the second result; and
determining an overall heat transfer coefficient of a heat exchanger according to the flow pattern of the to-be-tested fluid, and the flow and heat transfer associated parameters.

2. The method for predicting flow and heat transfer performance of all flow patterns in a crude oil heat exchanger according to claim 1, wherein the constructing an all-flow-pattern oil-water two-phase flow prediction model comprises:
obtaining a fluid-solid coupled flow and heat transfer unit in the heat exchanger;
acquiring structural parameters of the heat exchanger according to the flow and heat transfer unit;
constructing a physical model according to the structural parameters of the heat exchanger and performing mesh generation; and
constructing the all-flow-pattern oil-water two-phase flow prediction model according to the oil-water phase inversion model, the oil drop distribution based fully coupled PBM, and the water drop distribution based fully coupled PBM.

3. The method for predicting flow and heat transfer performance of all flow patterns in a crude oil heat exchanger according to claim 1, wherein the parameters of the to-be-tested fluid comprise:
an oil-water two-phase flow velocity, an oil-water two-phase phase holdup, an oil-water two-phase viscosity, and an oil-water two-phase density.

4. The method for predicting flow and heat transfer performance of all flow patterns in a crude oil heat exchanger according to claim 1, wherein the determining a dispersed phase of the to-be-tested fluid with the oil-water phase inversion model comprises:
calculating an input oil-water two-phase phase holdup of the to-be-tested fluid with a phase inversion point (PIP) empirical correlation of the phase inversion model to obtain an oil-water two-phase phase holdup in phase inversion; and
comparing the oil-water two-phase phase holdup in the phase inversion with the input oil-water two-phase phase holdup of the to-be-tested fluid to determine the dispersed phase of the to-be-tested fluid.

5. The method for predicting flow and heat transfer performance of all flow patterns in a crude oil heat exchanger according to claim 1, wherein the phase inversion model comprises:
a low-viscosity oil phase inversion model, an intermediate-viscosity oil phase inversion model, and a high-viscosity oil phase inversion model.

6. The method for predicting flow and heat transfer performance of all flow patterns in a crude oil heat exchanger according to claim 1, wherein the flow pattern of the to-be-tested fluid comprises:
a water-in-oil dispersed flow, a stratified flow, an oil-in-water dispersed flow, a hybrid dispersed flow, a hybrid stratified flow, an intermittent flow, and an annular flow.

7. The method for predicting flow and heat transfer performance of all flow patterns in a crude oil heat exchanger according to claim 1, wherein the flow and heat transfer associated parameters comprise:
an oil-water two-phase phase holdup distribution field, a size distribution, a pressure field, a pressure drop field, and a temperature field.

8. The method for predicting flow and heat transfer performance of all flow patterns in a crude oil heat exchanger according to claim 7, wherein the determining an overall heat transfer coefficient of a heat exchanger according to the flow pattern of the to-be-tested fluid, and the flow and heat transfer associated parameters comprises:
determining the flow pattern of the to-be-tested fluid according to the two-phase phase holdup distribution field and the size distribution;
calculating a local Nusselt number of the heat exchanger with the pressure field and the temperature field based on the flow pattern of the to-be-tested fluid to obtain a local deteriorated region of the heat exchanger;
calculating a Nusselt number and a Fanning friction factor of the heat exchanger according to the local deteriorated region of the heat exchanger; and
calculating the overall heat transfer coefficient of the heat exchanger according to the Nusselt number and the Fanning friction factor of the heat exchanger.
